(19) United States
(12) Patent Application Publication
(10) Pub. No.: US 2001/0010748 A1
(43) Pub. Date: Aug. 2, 2001

(54) Video signal processor for recording video signal digitally

(75) Inventors: Hisaji Murata, Osaka (JP); Toshihiro Miyoshi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 09/769,418

(22) Filed: Jan. 26, 2001

(30) Foreign Application Priority Data
Jan. 27, 2000 (JP) 2000-018272

(51) Int. Cl. H04N 9/79; H04N 11/04

(52) U.S. Cl. 386/40; 386/44

(57) ABSTRACT

In digitally recording an analog video signal on a storage medium, a data selector selects first luminance and first chrominance signals output from a Y/C separator. In response, a clock select switch selects a first clock signal with a first frequency. D/A converters sample the first luminance and first chrominance signals, output from the separator, at the first frequency, thereby converting them into analog signals to be output to a monitor. In reading out a digitally recorded video signal from the storage medium, the selector selects second luminance and second chrominance signals output from a digital codec and a chroma encoder, respectively. In response, the switch selects a second clock signal with a second frequency. The D/A converters sample the second luminance and second chrominance signals, output from the codec and the encoder, respectively, at the second frequency, thereby converting them into analog signals to be output to the monitor.

### BACKGROUND OF THE INVENTION

The present invention generally relates to a video signal processor, and more particularly relates to a video signal processor for use in a digital video cassette (DVC) recorder or digital video disc (DVD) player to record a video signal digitally.

Recently, various types of equipment, including DVC recorders and DVD players, for processing and recording a video signal digitally, have been popularized. On top of that, remarkable development of fine-line patterning in the semiconductor industry has tremendously increased the number of devices that can be integrated on a single LSI. Although a number of LSIs were usually needed to carry out a signal processing step, it is now possible to perform the same processing step using just one LSI.

In a signal processor for recording an analog television signal (i.e., a composite video signal) digitally, first, an A/D converter converts the composite video signal into a digital signal. Next, a Y/C separator separates the digital signal into constituent components including luminance and chrominance signals. The processor includes a D/A converter for externally monitoring these components, which are converted by the D/A converter into analog signals and then output to a monitor, for example. The chrominance signal, output from the Y/C separator, is demodulated into a set of color-difference signals by a chroma decoder. And the resultant luminance and color-difference signals are coded by a digital recording coded in a digitally recordable format and then recorded on a storage medium.

According to the NTSC standard (e.g., EIA RS-170), an analog television signal (i.e., a composite video signal) is a signal in which luminance and chrominance (or color-difference) signals have been multiplexed at a frequency of 14.3 MHz (i.e., 4 fsc). As a system clock signal for use in a digital signal processor to separate this multiplexed television signal into luminance and color-difference signals, a burst-locked clock signal with a frequency of 14.3 MHz is often used. This clock signal is adopted to utilize the properties of a color subcarrier. Specifically, a color subcarrier inverts its polarity on a line-by-line basis (or frame-by-frame basis when a video signal is processed field by field). Also, Cb and Cr signals are modulated by color subcarriers having respective phases that deviate from each other by 90 degrees. As used herein, the Cb and Cr signals will be collectively called “color-difference signals”.

On the other hand, in a signal processor for reading a digitally recorded video signal from a storage medium, a digital recording codec reads out video data from the storage medium and then decodes the data into luminance and color-difference signals. The color-difference signals are further encoded into a chrominance signal by a chroma encoder. Then, the resultant luminance and chrominance signals are converted into analog signals by a D/A converter, and eventually output to a monitor, for example.

According to a standard for a digitally encoded signal (e.g., ITU recommendation ITU-R. BT601), the sampling frequencies of the luminance and color-difference signals are 13.5 and 6.75 MHz, respectively. As a system clock signal for a digital signal processor handling a digitally encoded signal, a line-locked clock signal with a frequency of 13.5 MHz is often used.

In implementing a video signal processor for digitally recording an analog television signal on, and reading a digitally recorded video signal from, a storage medium, burst-and line-locked clock signals with respective frequencies of 14.3 and 13.5 MHz are used as system clock signals for write and read heads, respectively. As can be seen, the digital signal processor must use mutually different system clock frequencies for the signals converted into analog signals and then output to a monitor during write and read operations, respectively. Thus, the processor has to include two sets of D/A converters for the two types of signals output to the monitor during write and read operations, respectively.

### SUMMARY OF THE INVENTION

It is therefore an object of the present invention to provide a video signal processor that needs a reduced number of components to cut down the cost thereof.

A video signal processor according to the present invention includes A/D converter, Y/C separator, chroma decoder, first D/D converter, digital codec, chroma encoder, data selecting means, clock selecting means and D/A converters.

The A/D converter samples an analog video signal at a first frequency and converts it into a digital video signal. The separator separates the digital video signal into a first luminance signal and a first chrominance signal. The decoder demodulates the first chrominance signal into a first set of color-difference signals. The first D/D converter re-samples the first luminance signal and the first set of color-difference signals at a second frequency. The codec digitally encodes the first luminance signal and the first set of color-difference signals, output from the first D/D converter, to produce a write signal. The codec also samples a digitally encoded read signal at the second frequency to decode it into a second luminance signal and a second set of color-difference signals. The encoder modulates the second set of color-difference signals into a second chrominance signal. The data selecting means selects either the first luminance and first chrominance signals, output from the separator, or the second luminance and second chrominance signals output from the codec and the encoder, respectively. If the data selecting means has selected the first luminance and first chrominance signals, the clock selecting means selects a first clock signal with the first frequency. Alternatively, if the data selecting means has selected the second luminance and second chrominance signals, the clock selecting means selects a second clock signal with the second frequency. And the D/A converters sample the luminance and chrominance signals, selected by the data selecting means, at the frequency of the clock signal selected by the clock selecting means, and converts those signals into analog signals.

In digitally recording an analog video signal on a storage medium using this processor, the data selecting means selects the first luminance and first chrominance signals output from the separator. In response, the clock selecting means selects the first clock signal with the first frequency. And the D/A converters sample the first luminance and first chrominance signals, output from the separator, at the first frequency and then convert those signals into analog signals, which will be eventually output to a monitor, for example. In this manner, the contents of the video signals to be recorded on the storage medium can be checked on the monitor.

On the other hand, in reading out a digitally recorded video signal from a storage medium, the data selecting means selects the second luminance and second chrominance signals output from the codec and the encoder, respectively. In response, the clock selecting means selects the second clock signal with the second frequency. And the D/A converters sample the second luminance and second chrominance signals, output from the codec and the encoder, respectively, at the second frequency and then convert those signals into analog signals, which will be eventually output to the monitor, for example. In this manner, the contents of the video signal that has been read out from the storage medium can be checked on the monitor.

The video signal processor of the present invention includes the data and clock selecting means. Thus, whether an analog video signal is digitally recorded on a storage medium or a digitally recorded video signal is read from the medium, a rate at which each signal to be D/A converted by its associated D/A converter was sampled is equal to a rate at which the converter samples it. Accordingly, there is no need to provide two sets of D/A converters for signals to be monitored in digitally recording the analog video signal on the medium and for signals to be monitored in reading the digitally recorded video signal from the medium, respectively. As a result, the number of components required and the cost of the processor can be both reduced.

In one embodiment of the present invention, the processor preferably further includes amplitude correcting means. The correcting means makes up a difference in amplitude between the first luminance and first chrominance signals output from the separator and the second luminance and second chrominance signals output from the codec and the encoder, respectively.

The level of a signal output to a monitor when an analog video signal is digitally recorded on a storage medium is preferably equal to that of a signal output to the monitor when a digitally recorded video signal is read out from the medium. Actually, though, the first luminance and first chrominance signals output from the separator when an analog video signal is digitally recorded on a storage medium is different in level from the second luminance and chrominance signals output from the codec and encoder when a digitally recorded video signal is read from the medium.

However, the processor of the present invention includes the amplitude correcting means. Accordingly, it is possible to make up the difference in amplitude between the first luminance and first chrominance signals output from the separator and the second luminance and second chrominance signals output from the codec and the encoder, respectively. As a result, the signal output to the monitor when an analog video signal is digitally recorded on a storage medium can have its level equalized with that of the signal output to the monitor when a digitally recorded video signal is read from the medium.

Without the amplitude correcting means, two sets of analog amplifiers should be separately provided to amplify signals output from the D/A converters when an analog video signal is digitally recorded on a storage medium and signals output from the D/A converters when a digitally recorded video signal is read from the medium. This is because the signal output to the monitor during writing should have the same level as the signal output to the monitor during reading.

However, the processor of this embodiment does not have to include the two sets of analog amplifiers. As a result, the number of analog amplifiers required and the cost of the processor can be both reduced.

In another embodiment of the present invention, the correcting means may include an amplitude changer for changing the amplitude of the first luminance and first chrominance signals output from the separator.

The processor of that embodiment includes the amplitude changer. Thus, the first luminance and first chrominance signals output from the separator can have their amplitude equalized with that of the second luminance and second chrominance signal output from the codec and the encoder, respectively.

In an alternative embodiment, the correcting means may include an amplitude changer for changing the amplitude of the second luminance and second chrominance signals output from the codec and the encoder, respectively.

The processor of that embodiment includes the amplitude changer. Thus, the second luminance and second chrominance signals output from the codec and the encoder, respectively, can have their amplitude equalized with that of the first luminance and first chrominance signals output from the separator.

Another video signal processor according to the present invention includes A/D converter, Y/C separator, chroma decoder, first D/D converter, digital codec, second D/D converter, chroma encoder, data selecting means and D/A converters.

The A/D converter samples an analog video signal at a first frequency and converts it into a digital video signal. The separator separates the digital video signal into a first luminance signal and a first chrominance signal. The decoder demodulates the first chrominance signal into a first set of color-difference signals. The first D/D converter re-samples the first luminance signal and the first set of color-difference signals at a second frequency. The codec digitally encodes the first luminance signal and the first set of color-difference signals, output from the first D/D converter, to produce a write signal. The codec also samples a digitally encoded read signal at the second frequency to decode it into a second luminance signal and a second set of color-difference signals. The second D/D converter re-samples the second luminance signal and the second set of color-difference signals at the first frequency. The encoder modulates the second set of color-difference signals, output from the second D/D converter, into a second chrominance signal. The data selecting means selects either the first luminance and first chrominance signals, output from the separator, or the second luminance and second chrominance signals, output from the second D/D converter and the encoder, respectively. And the D/A converters sample the luminance and chrominance signals, selected by the data selecting means, at the first frequency and convert them into analog signals.

In digitally recording an analog video signal on a storage medium using this processor, the data selecting means selects the first luminance and first chrominance signals output from the separator. And the D/A converters sample the first luminance and first chrominance signals, output from the separator, at the first frequency and then convert those signals into analog signals, which will be eventually output to a monitor, for example. In this manner, the contents of the video signals to be recorded on the storage medium can be checked on the monitor.

On the other hand, in reading out a digitally recorded video signal from a storage medium, the data selecting means selects the second luminance and second chrominance signals output from the second D/D converter and the encoder, respectively. And the D/A converters sample the second luminance and second chrominance signals, output from the second D/D converter and the encoder, respectively, at the first frequency and then convert those signals into analog signals, which will be eventually output to the monitor, for example. In this manner, the contents of the video signal that has been read out from the storage medium can be checked on the monitor.

The video signal processor of the present invention includes the data selecting means and the second D/D converter. Thus, whether an analog video signal is digitally recorded on a storage medium or a digitally recorded video signal is read from the medium, a rate at which each signal to be D/A converted by its associated D/A converter was sampled is equal to a rate at which the converter samples it. Accordingly, there is no need to provide two sets of D/A converters for signals to be monitored in digitally recording the analog video signal on the medium and for signals to be monitored in reading the digitally recorded video signal from the medium, respectively. As a result, the number of components required and the cost of the processor can be both reduced.

Still another video signal processor according to the present invention includes A/D converter, Y/C separator, chroma decoder, first D/D converter, digital codec, second D/D converter, data selecting means, chroma encoder and D/A converters.

The A/D converter samples an analog video signal at a first frequency and converts it into a digital video signal. The separator separates the digital video signal into a first luminance signal and a first chrominance signal. The decoder demodulates the first chrominance signal into a first set of color-difference signals. The first D/D converter re-samples the first luminance signal and the first set of color-difference signals at a second frequency. The codec digitally encodes the first luminance signal and the first set of color-difference signals, output from the first D/D converter, to produce a write signal. The codec also samples a digitally encoded read signal at the second frequency to decode it into a second luminance signal and a second set of color-difference signals. The second D/D converter re-samples the second luminance signal and the second set of color-difference signals at the first frequency. The data selecting means selects either the first luminance signal and the first set of color-difference signals, output from the separator and the decoder, respectively, or the second luminance signal and the second set of color-difference signals output from the second D/D converter. The encoder modulates the first or second set of color-difference signals, selected by the data selecting means, into a second chrominance signal. And the D/A converters sample the luminance signal, selected by the data selecting means, and the second chrominance signal, output from the encoder, at the first frequency and convert them into analog signals.

In digitally recording an analog video signal on a storage medium using this processor, the data selecting means selects the first luminance signal and the first set of color-difference signals output from the separator and the decoder, respectively. In response, the encoder modulates the first set of color-difference signals, output from the decoder, into the second chrominance signal. And the D/A converters sample the first luminance and second chrominance signals, output from the separator and the encoder, respectively, at the first frequency and then convert those signals into analog signals, which will be eventually output to a monitor, for example. In this manner, the contents of the video signals to be recorded on the storage medium can be checked on the monitor.

On the other hand, in reading out a digitally recorded video signal from a storage medium, the data selecting means selects the second luminance signal and the second set of color-difference signals output from the second D/D converter. In response, the encoder modulates the second set of color-difference signals, output from the second D/D converter, into the second chrominance signal. And the D/A converters sample the second luminance and second chrominance signals, output from the second D/D converter and the encoder, respectively, at the first frequency and then convert those signals into analog signals, which will be eventually output to a monitor, for example. In this manner, the contents of the video signal that has been read out from the storage medium can be checked on the monitor.

The video signal processor of the present invention includes the data selecting means and the second D/D converter. Thus, whether an analog video signal is digitally recorded on a storage medium or a digitally recorded video signal is read from the medium, a rate at which each signal to be D/A converted by its associated D/A converter was sampled is equal to a rate at which the converter samples it. Accordingly, there is no need to provide two sets of D/A converters for signals to be monitored in digitally recording the analog video signal on the medium and for signals to be monitored in reading the digitally recorded video signal from the medium, respectively. As a result, the number of components required and the cost of the processor can be both reduced.

Yet another video signal processor according to the present invention includes A/D converter, Y/C separator, chroma decoder, first D/D converter, digital codec, data selecting means, chroma encoder and D/A converters.

The A/D converter samples an analog video signal at a first frequency and converts it into a digital video signal. The separator separates the digital video signal into a first luminance signal and a first chrominance signal. The decoder demodulates the first chrominance signal into a first set of color-difference signals. The first D/D converter re-samples the first luminance signal and the first set of color-difference signals at a second frequency. The codec digitally encodes the first luminance signal and the first set of color-difference signals, output from the first D/D converter, to produce a write signal. The codec also samples a digitally encoded read signal at the second frequency to decode it into a second luminance signal and a second set of color-difference signals. The data selecting means selects either the first luminance signal and the first set of color-difference signals output from the first D/D converter or the second luminance signal and the second set of color-difference signals output from the codec. The encoder modulates the first or second set of color-difference signals, selected by the data selecting means, into a second chrominance signal. And the D/A converters sample the luminance signal, selected by the data selecting means, and the second chrominance signal, output from the encoder, at the second frequency and convert them into analog signals.

In digitally recording an analog video signal on a storage medium using this processor, the data selecting means selects the first luminance signal and the first set of color-difference signals output from the first D/D converter. In response, the encoder modulates the first set of color-difference signals, output from the first D/D converter, into the second chrominance signal. And the D/A converters sample the first luminance and second chrominance signals, output from the first D/D converter and the encoder, respectively, at the second frequency and then convert those signals into analog signals, which will be eventually output to a monitor, for example. In this manner, the contents of the video signals to be recorded on the storage medium can be checked on the monitor.

On the other hand, in reading out a digitally recorded video signal from a storage medium, the data selecting means selects the second luminance signal and the second set of color-difference signals output from the codec. In response, the encoder modulates the second set of color-difference signals, output from the digital codec, into the second chrominance signal. And the D/A converters sample the second luminance and second chrominance signals, output from the codec and the encoder, respectively, at the second frequency and then convert those signals into analog signals, which will be eventually output to a monitor, for example. In this manner, the contents of the video signal that has been read out from the storage medium can be checked on the monitor.

The video signal processor of the present invention includes the data selecting means and the first D/D converter. Thus, whether an analog video signal is digitally recorded on a storage medium or a digitally recorded video signal is read from the medium, a rate at which each signal to be D/A converted by its associated D/A converter was sampled is equal to a rate at which the converter samples it. Accordingly, there is no need to provide two sets of D/A converters for signals to be monitored in digitally recording the analog video signal on the medium and for signals to be monitored in reading the digitally recorded video signal from the medium, respectively. As a result, the number of components required and the cost of the processor can be both reduced.

### BRIEF DESCRIPTION OF THE DRAWINGS

FIGS. 1 through 5 are block diagrams illustrating overall configurations for video signal processors according to first, second, third, fourth and fifth embodiments of the present invention.

### DESCRIPTION OF THE PREFERRED EMBODIMENTS

Hereinafter, preferred embodiments of the present invention will be described in detail with reference to the accompanying drawings, in which like or the same parts are identified by the same reference numeral for the sake of simplicity of description.

EMBODIMENT 1

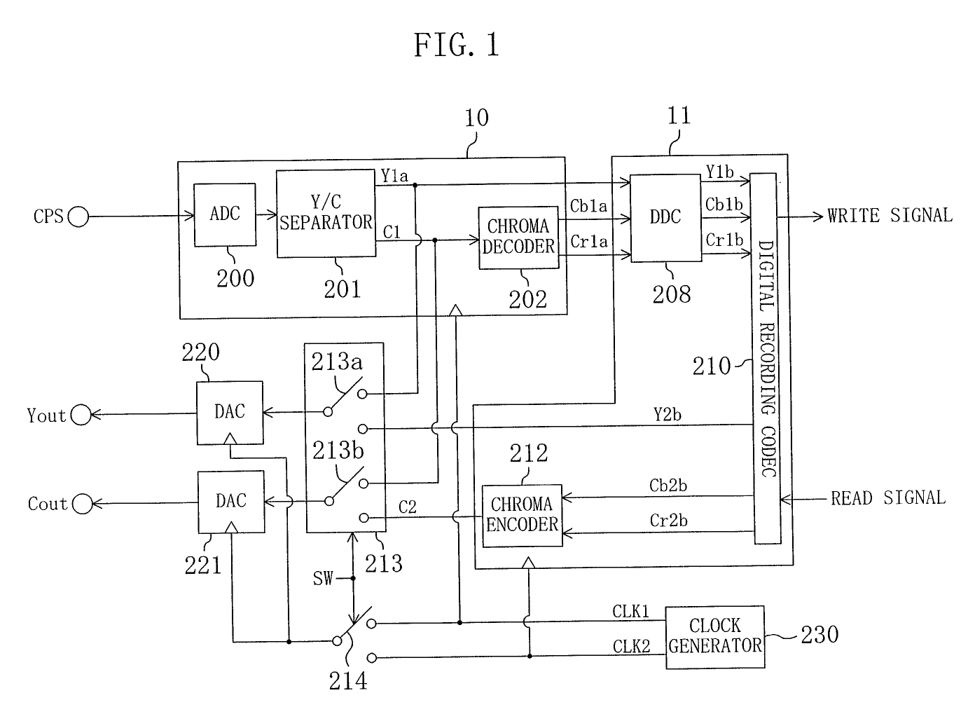

FIG. 1 is a block diagram illustrating an overall configuration for a video signal processor according to a first embodiment of the present invention. As shown in FIG. 1, the processor includes write block 10, read block 11, data selector 213, clock generator 230, clock select switch 214 and D/A converters 220 and 221.

The clock generator 230 generates a burst-locked clock signal CLK1 with a frequency of 14.3 MHz and a line-locked clock signal CLK2 with a frequency of 13.5 MHz. The write and read blocks 10 and 11 are operating responsive to the burst-and line-locked clock signals CLK1 and CLK2, respectively.

The write block 10 includes A/D converter 200, Y/C separator 201 and chroma decoder 202. The A/D converter 200 samples an analog television signal CPS at the frequency of the burst-locked clock signal CLK1 (i.e., 14.3 MHz) and converts it into a digital signal. The separator 201 separates the digital signal, output from the A/D converter 200, into a luminance signal Y1a and a chrominance signal C1. The decoder 202 demodulates the chrominance signal C1, output from the separator 201, into color-difference signals Cb1a and Cr1a.

The read block 11 includes D/D converter 208, digital recording codec 210 and chroma encoder 212. The D/D converter 208 re-samples the luminance signal Y1a and color-difference signals Cb1a and Cr1a, which have been sampled at the frequency of the burst-locked clock signal CLK1 (i.e., 14.3 MHz), at the frequency of the line-locked clock signal CLK2 (i.e., 13.5 MHz). The codec 210 digitally encodes the luminance signal Y1b and color-difference signals Cb1b and Cr1b, output from the D/D converter 208, thereby producing a write signal. Also, the codec 210 samples a digitally encoded read signal at the frequency of the line-locked clock signal CLK2 (i.e., 13.5 MHz), thereby decoding the read signal into luminance signal Y2b and color-difference signals Cb2b and Cr2b. The encoder 212 modulates the color-difference signals Cb2b and Cr2b, output from the codec 210, into a chrominance signal C2.

The data selector 213 includes data select switches 213a and 213b. Responsive to a switch signal SW, the switch 213a selects either the luminance signal Y1a output from the separator 201 or the luminance signal Y2b output from the codec 210. On the other hand, responsive to the switch signal SW, the switch 213b selects either the chrominance signal C1 output from the separator 201 or the chrominance signal C2 output from the encoder 212.

Also responsive to the switch signal SW, the switch 214 selects either the burst- or line-locked clock signal CLK1 or CLK2 output from the generator 230.

The D/A converter 220 samples the luminance signal Y1a or Y2b, selected by the switch 213a, at the frequency of the clock signal CLK1 or CLK2 selected by the switch 214, thereby converting it into an analog luminance signal Yout. In the same way, the D/A converter 221 samples the chrominance signal C1 or C2, selected by the switch 213b, at the frequency of the clock signal CLK1 or CLK2 selected by the switch 214, thereby converting it into an analog chrominance signal Cout.

Hereinafter, it will be described how the processor with such a configuration performs write and read operations.

### (1) Write operation

The A/D converter 200 samples the input analog television signal CPS at the frequency of the burst-locked clock signal CLK1 (i.e., 14.3 MHz) and converts it into a digital signal. Then, the separator 201 separates the output digital signal of the A/D converter 200 into the luminance signal Y1a and chrominance signal C1. Next, the decoder 202 demodulates the output chrominance signal C1 of the separator 201 into the color-difference signals Cb1a and Cr1a. Subsequently, the D/D converter 208 re-samples the luminance signal Y1a and color-difference signals Cb1a and Cr1a, which have been sampled at the frequency of the burst-locked clock signal CLK1 (i.e., 14.3 MHz), at the frequency of the line-locked clock signal CLK2 (i.e., 13.5 MHz). Then, the codec 210 digitally encodes the re-sampled luminance signal Y1b and color-difference signals Cb1b and Cr1b, thereby producing a write signal that can be recorded on a storage medium. Finally, the write signal is recorded on the storage medium.

During the write operation, the switch signal SW is in logical one state (i.e., at the H level). Responsive to the H-level switch signal SW, the switch 213a selects the luminance signal Y1a output from the separator 201. As a result, the luminance signal Y1a is delivered from the separator 201 to the D/A converter 220. The luminance signal Y1a is a digital signal that was sampled at the frequency of the burstlocked clock signal CLK1 (i.e., 14.3 MHz). Also, responsive to the H-level switch signal SW, the switch 213b selects the chrominance signal C1 output from the separator 201. As a result, the chrominance signal C1 is delivered from the separator 201 to the D/A converter 221. The chrominance signal C1 is also a digital signal that was sampled at the frequency of the burst-locked clock signal CLK1 (i.e., 14.3 MHz). Also responsive to the H-level switch signal SW, the switch 214 selects the burst-locked clock signal CLK1. As a result, the burst-locked clock signal CLK1 is supplied to the D/A converters 220 and 221.

The D/A converter 220 samples the luminance signal Y1a, output from the separator 201, at the frequency of the burst-locked clock signal (i.e., 14.3 MHz), thereby converting it into the analog luminance signal Yout. In the same way, the D/A converter 221 samples the chrominance signal C1, output from the separator 201, at the frequency of the burst-locked clock signal (i.e., 14.3 MHz), thereby converting it into the analog chrominance signal Cout. And these analog luminance and chrominance signals Yout and Cout are eventually output to the monitor. As a result, the contents of the video signals to be recorded on the storage medium can be checked on the monitor.

### (2) Read operation

The codec 210 samples a digitally encoded read signal, which has been read out from a storage medium, at the frequency of the line-locked clock signal CLK2 (i.e., 13.5 MHz), thereby decoding the read signal into luminance signal Y2b and color-difference signals Cb2b and Cr2b. The encoder 212 modulates the color-difference signals Cb2b and Cr2b into the chrominance signal C2.

During the read operation, the switch signal SW is in logical zero state (i.e., at the L level). Responsive to the L-level switch signal SW, the switch 213a selects the luminance signal Y2b output from the codec 210. As a result, the luminance signal Y2b is delivered from the codec 210 to the D/A converter 220. The luminance signal Y2b is a digital signal that was sampled at the frequency of the line-locked clock signal CLK2 (i.e., 13.5 MHz). Also, responsive to the L-level switch signal SW, the switch 213b selects the chrominance signal C2 output from the encoder 212. As a result, the chrominance signal C2 is delivered from the encoder 212 to the D/A converter 221. The chrominance signal C2 is a digital signal that was sampled at the frequency of the line-locked clock signal CLK2 (i.e., 13.5 MHz). Also responsive to the L-level switch signal SW, the switch 214 selects the line-locked clock signal CLK2. As a result, the line-locked clock signal CLK2 is supplied to the D/A converters 220 and 221.

The D/A converter 220 samples the luminance signal Y2b, output from the codec 210, at the frequency of the line-locked clock signal CLK2 (i.e., 13.5 MHz), thereby converting it into the analog luminance signal Yout. In the same way, the D/A converter 221 samples the chrominance signal C2, output from the encoder 212, at the frequency of the line-locked clock signal CLK2 (i.e., 13.5 MHz), thereby converting it into the analog chrominance signal Cout. And these analog luminance and chrominance signals Yout and Cout are eventually output to a monitor. As a result, the contents of the video signal that has been read out from the storage medium can be checked on the monitor.

The video signal processor of the first embodiment includes the data selector 213 and clock select switch 214. Thus, whether the processor is writing or reading, the rate at which each signal to be D/A converted by the D/A converter 220 or 221 was sampled is equal to the rate at which the D/A converter 220 or 221 samples it. Thus, there is no need to separately provide two sets of D/A converters for signals to be monitored during writing and for signals to be monitored during reading, respectively. As a result, the number of D/A converters required and the cost of the processor can be both reduced.

EMBODIMENT 2

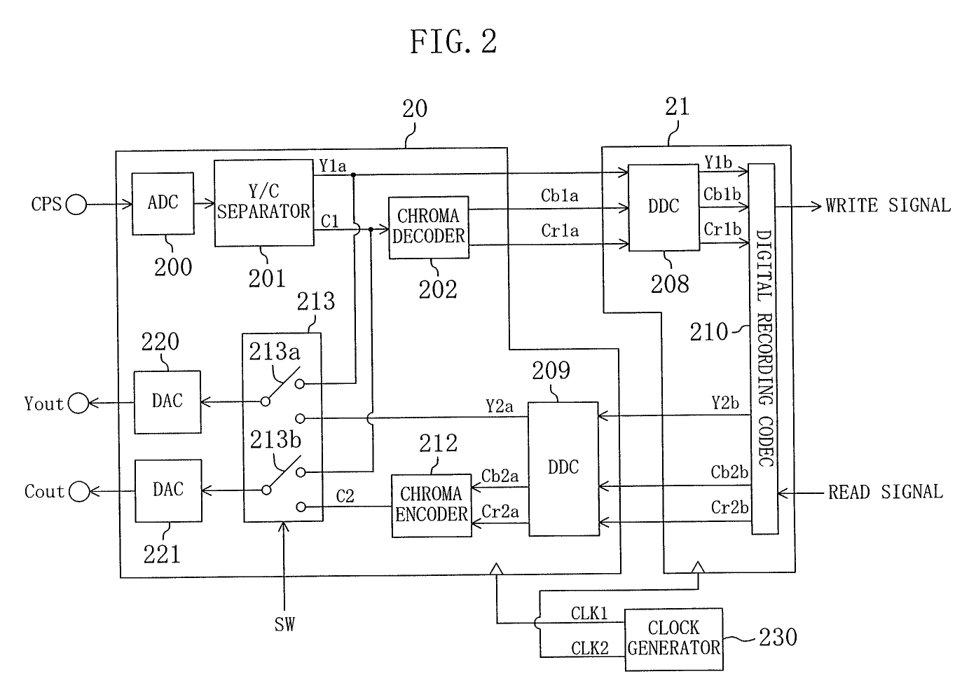

FIG. 2 is a block diagram illustrating an overall configuration for a video signal processor according to a second embodiment of the present invention. As shown in FIG. 2, the processor includes first and second blocks 20 and 21 and the clock generator 230.

The first block 20 includes the A/D converter 200, Y/C separator 201, chroma decoder 202, chroma encoder 212, data selector 213, D/D converter 209 and D/A converters 220 and 221. The selector 213 includes data select switches 213a and 213b. The D/D converter 209 re-samples the luminance signal Y2b and color-difference signals Cb2b and Cr2b, which were sampled at the frequency of the line-locked clock signal CLK2 (i.e., 13.5 MHz), at the frequency of the burst-locked clock signal CLK1 (i.e., 14.3 MHz).

The second block 21 includes the D/D converter 208 and digital recording codec 210.

The first and second blocks 20 and 21 operate responsive to the burst-and line-locked clock signals CLK1 and CLK2, respectively.

Hereinafter, it will be described how the video signal processor with such a configuration performs write and read operations.

### (1) Write operation

As in the first embodiment, an input analog television signal CPS is converted into a write signal that is recordable on a storage medium. And then the write signal is recorded on the storage medium.

During the write operation, the switch signal SW is in logical one state (i.e., at the H level). Responsive to the H-level switch signal SW, the switch 213a selects the luminance signal Y1a output from the separator 201. As a result, the luminance signal Y1a is delivered from the separator 201 to the D/A converter 220. The luminance signal Y1a is a digital signal that was sampled at the frequency of the burst-locked clock signal CLK1 (i.e., 14.3 MHz). Also, responsive to the H-level switch signal SW, the switch 213b selects the chrominance signal C1 output from the separator 201. As a result, the chrominance signal C1 is delivered from the separator 201 to the D/A converter 221. The chrominance signal C1 is a digital signal that was sampled at the frequency of the burst-locked clock signal CLK1 (i.e., 14.3 MHz). Also, the burst-locked clock signal CLK1 is supplied to the D/A converters 220 and 221 included in the first block 20.

The D/A converter 220 samples the luminance signal Y1a, output from the separator 201, at the frequency of the burst-locked clock signal CLK1 (i.e., 14.3 MHz), thereby converting it into an analog luminance signal Yout. In the same way, the D/A converter 221 samples the chrominance signal C1, output from the separator 201, at the frequency of the burst-locked clock signal CLK1 (i.e., 14.3 MHz), thereby converting it into an analog chrominance signal Cout. These analog luminance and chrominance signals Yout and Cout are eventually output to a monitor, for example. As a result, the contents of the video signals to be recorded on the storage medium can be checked on the monitor.

### (2) Read operation

The codec 210 samples a digitally encoded read signal, which has been read out from a storage medium, at the frequency of the line-locked clock signal CLK2 (i.e., 13.5 MHz), thereby decoding it into the luminance signal Y2b and color-difference signals Cb2b and Cr2b. Then, the D/D converter 209 re-samples the luminance signal Y2b and color-difference signals Cb2b and Cr2b, which were sampled at the frequency of the line-locked clock signal CLK2 (i.e., 13.5 MHz), at the frequency of the burst-locked clock signal CLK1 (i.e., 14.3 MHz). Subsequently, the encoder 212 modulates the re-sampled color-difference signals Cb2a and Cr2a into the chrominance signal C2.

During the read operation, the switch signal SW is in logical zero state (i.e., at the L level). Responsive to the L-level switch signal SW, the switch 213a selects the luminance signal Y2a that has been re-sampled by the D/D converter 209. As a result, the luminance signal Y2a is delivered from the D/D converter 209 to the D/A converter 220. The luminance signal Y2a is a digital signal that was sampled at the frequency of the burst-locked clock signal CLK1 (i.e., 14.3 MHz). Also, responsive to the L-level switch signal SW, the switch 213b selects the chrominance signal C2 output from the encoder 212. As a result, the chrominance signal C2 is delivered from the encoder 212 to the D/A converter 221. The chrominance signal C2 is a digital signal that was sampled at the frequency of the burst-locked clock signal CLK1 (i.e., 14.3 MHz). Also, the burst-locked clock signal CLK1 is supplied to the D/A converters 220 and 221 included in the first block 20.

The D/A converter 220 samples the luminance signal Y2a, output from the D/D converter 209, at the frequency of the burst-locked clock signal CLK1 (i.e., 14.3 MHz), thereby converting it into an analog luminance signal Yout. In the same way, the D/A converter 221 samples the chrominance signal C2, output from the encoder 212, at the frequency of the burst-locked clock signal CLK1 (i.e., 14.3 MHz), thereby converting it into an analog chrominance signal Cout. These analog luminance and chrominance signals Yout and Cout are eventually output to a monitor, for example. As a result, the contents of the video signal that has been read out from the storage medium can be checked on the monitor.

The video signal processor of the second embodiment includes the data selector 213 and D/D converter 209. Thus, whether the processor is writing or reading, the rate at which each signal to be D/A converted by the D/A converter 220 or 221 was sampled is equal to the rate at which the D/A converter 220 or 221 samples it. Thus, there is no need to separately provide two sets of D/A converters for signals to be monitored during writing and for signals to be monitored during reading, respectively. As a result, the number of D/A converters required and the cost of the processor can be both reduced.

### EMBODIMENT 3

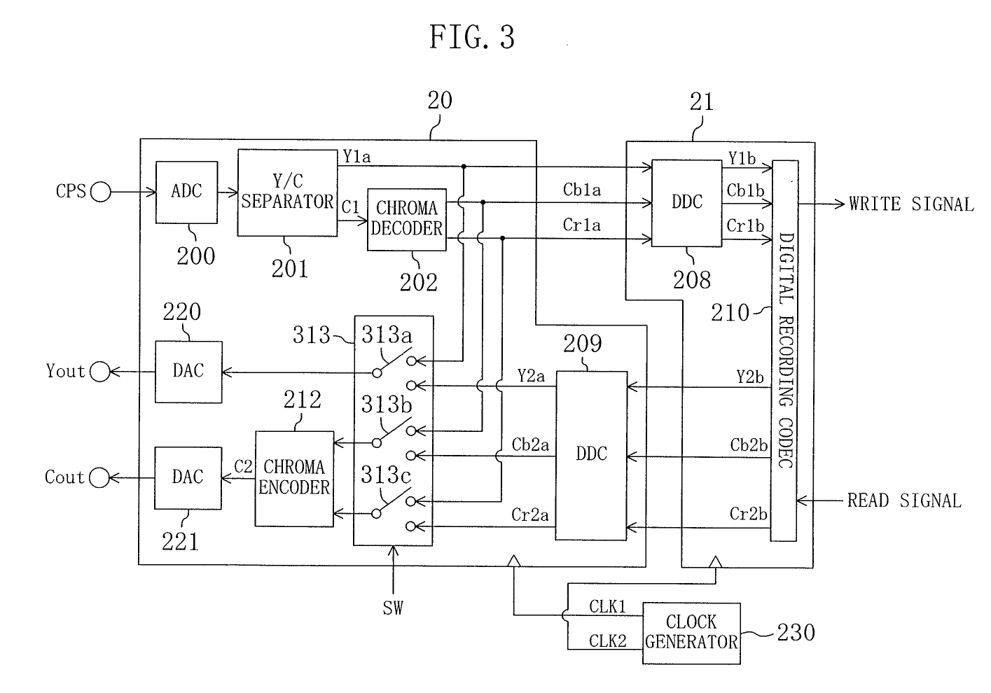

FIG. 3 is a block diagram illustrating an overall configuration for a video signal processor according to a third embodiment of the present invention. As shown in FIG. 3, the processor includes a data selector 313 instead of the data selector 213 shown in FIG. 2. In the other respects, the processor shown in FIG. 3 has almost the same configuration as the counterpart shown in FIG. 2.

The selector 313 includes data select switches 313a, 313b and 313c. Responsive to the switch signal SW, the switch 313a selects either the luminance signal Y1a output from the separator 201 or the luminance signal Y2a output from the D/D converter 209. Also, responsive to the switch signal SW, the switch 313b selects either the color-difference signals Cb1a output from the decoder 202 or the color-difference signal Cb2a output from the D/D converter 209. And responsive to the switch signal SW, the switch 313c selects either the color-difference signals Cr1a output from the decoder 202 or the color-difference signal Cr2a output from the D/D converter 209.

Hereinafter, it will be briefly described how the video signal processor with such a configuration performs a write operation. Responsive to the H-level switch signal SW, the switch 313a selects the luminance signal Y1a output from the separator 201. As a result, the luminance signal Y1a is delivered from the separator 201 to the D/A converter 220. The luminance signal Y1a is a digital signal that was sampled at the frequency of the burst-locked clock signal CLK1 (i.e., 14.3 MHz). Also, responsive to the H-level switch signal SW, the switches 313b and 313c select the color-difference signals Cb1a and Cr1a output from the decoder 202. As a result, the color-difference signals Cb1a and Cr1a are delivered from the decoder 202 to the encoder 212. The encoder 212 modulates the color-difference signals Cb1a and Cr1a into the chrominance signal C2, which is supplied to the D/A converter 221. The chrominance signal C2 is a digital signal that was sampled at the frequency of the burst-locked clock signal CLK1 (i.e., 14.3 MHz). Also, the burst-locked clock signal CLK1 is supplied to the D/A converters 220 and 221 included in the first block 20.

The D/A converter 220 samples the luminance signal Y1a, output from the separator 201, at the frequency of the burst-locked clock signal CLK1 (i.e., 14.3 MHz), thereby converting it into an analog luminance signal Yout. In the same way, the D/A converter 221 samples the chrominance signal C2, output from the encoder 212, at the frequency of the burst-locked clock signal CLK1 (i.e., 14.3 MHz), thereby converting it into an analog chrominance signal Cout.

On the other hand, the processor performs a read operation in the following manner. During the read operation, responsive to the L-level switch signal SW, the switch 313a selects the luminance signal Y2a that has been re-sampled by the D/D converter 209. As a result, the luminance signal Y2a is delivered from the D/D converter 209 to the D/A converter 220. The luminance signal Y2a is a digital signal that was sampled at the frequency of the burst-locked clock signal CLK1 (i.e., 14.3 MHz). Also, responsive to the L-level switch signal SW, the switches 313b and 313c select the color-difference signals Cb2a and Cr2a output from the D/D converter 209. As a result, the color-difference signals Cb2a and Cr2a are delivered from the D/D converter 209 to the encoder 212. The encoder 212 modulates the color-difference signals Cb2a and Cr2a into the chrominance signal C2, which is supplied to the D/A converter 221. The chrominance signal C2 is a digital signal that was sampled at the frequency of the burst-locked clock signal CLK1 (i.e., 14.3 MHz). Also, the burst-locked clock signal CLK1 is supplied to the D/A converters 220 and 221 included in the first block 20.

The D/A converter 220 samples the luminance signal Y2a, output from the D/D converter 209, at the frequency of the burst-locked clock signal CLK1 (i.e., 14.3 MHz), thereby converting it into an analog luminance signal Yout. In the same way, the D/A converter 221 samples the chrominance signal C2, output from the encoder 212, at the frequency of the burst-locked clock signal CLK1 (i.e., 14.3 MHz), thereby converting it into an analog chrominance signal Cout.

The video signal processor of the third embodiment also includes the data selector 313 and D/D converter 209. Thus, as in the second embodiment, whether the processor is writing or reading, the rate at which each signal to be D/A converted by the D/A converter 220 or 221 was sampled is equal to the rate at which the D/A converter 220 or 221 samples it. Thus, there is no need to separately provide two sets of D/A converters for signals to be monitored during writing and for signals to be monitored during reading, respectively. As a result, the number of D/A converters required and the cost of the processor can be both reduced.

EMBODIMENT 4

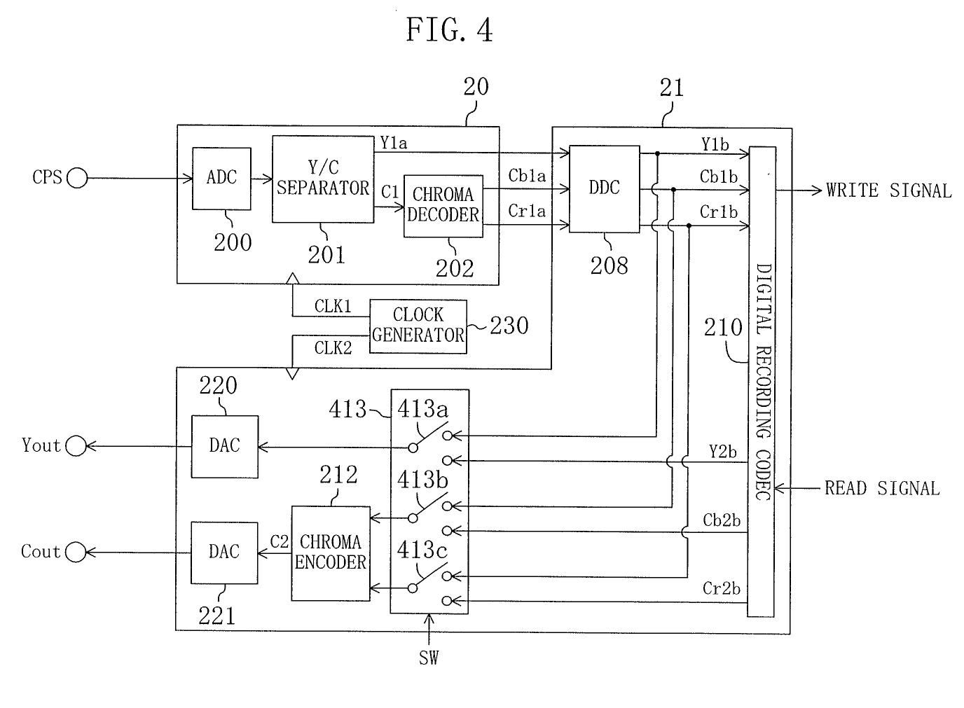

FIG. 4 is a block diagram illustrating an overall configuration for a video signal processor according to a fourth embodiment of the present invention. The processor shown in FIG. 4 includes no D/D converter 209 shown in FIG. 3 but does include a data selector 413 instead of the data selector 313 shown in FIG. 3. In the processor shown in FIG. 3, the D/A converters 220 and 221 and chroma encoder 212 are included in the first block 20. In the processor shown in FIG. 4 on the other hand, the D/A converters 220 and 221 and chroma encoder 212 are included in the second block 20. In the other respects, the processor shown in FIG. 4 has the same configuration as the counterpart shown in FIG. 3.

The selector 413 includes data select switches 413a, 413b and 413c. Responsive to the switch signal SW, the switch 413a selects either the luminance signal Y1b output from the D/D converter 208 or the luminance signal Y2b output from the digital recording codec 210. Also, responsive to the switch signal SW, the switch 413b selects either the color-difference signal Cb1b output from the D/D converter 208 or the color-difference signal Cb2b output from the codec 210. And responsive to the switch signal SW, the switch 413c selects either the color-difference signal Cr1b output from the D/D converter 208 or the color-difference signal Cr2b output from the codec 210.

Hereinafter, it will be briefly described how the processor with such a configuration performs a write operation. Responsive to the H-level switch signal SW, the switch 413a selects the luminance signal Y1b output from the D/D converter 208. As a result, the luminance signal Y1b is delivered from the D/D converter 208 to the D/A converter 220. The luminance signal Y1b is a digital signal that was sampled at the frequency of the line-locked clock signal CLK2 (i.e., 13.5 MHz). Also, responsive to the H-level switch signal SW, the switches 413b and 413c select the color-difference signals Cb1b and Cr1b output from the D/D converter 208. As a result, the color-difference signals Cb1b and Cr1b are delivered from the D/D converter 208 to the encoder 212. In response, the encoder 212 modulates the color-difference signals Cb1b and Cr1b into the chrominance signal C2, which is supplied to the D/A converter 221. The chrominance signal C2 is a digital signal that was sampled at the frequency of the line-locked clock signal CLK2 (i.e., 13.5 MHz). Also, the line-locked clock signal CLK2 is supplied to the D/A converters 220 and 221 included in the second block 21.

The D/A converter 220 samples the luminance signal Y1b, output from the D/D converter 208, at the frequency of the line-locked clock signal CLK2 (i.e., 13.5 MHz), thereby converting it into an analog luminance signal Yout. In the same way, the D/A converter 221 samples the chrominance signal C2, output from the encoder 212, at the frequency of the linelocked clock signal CLK2 (i.e., 13.5 MHz), thereby converting it into an analog chrominance signal Cout.

On the other hand, the processor performs a read operation in the following manner. During the read operation, responsive to the L-level switch signal SW, the switch 413a selects the luminance signal Y2b output from the codec 210. As a result, the luminance signal Y2b is delivered from the codec 210 to the D/A converter 220. The luminance signal Y2b is a digital signal that was sampled at the frequency of the line-locked clock signal CLK2 (i.e., 13.5 MHz). Also, responsive to the L-level switch signal SW, the switches 413b and 413c select the color-difference signals Cb2b and Cr2b output from the codec 210. As a result, the color-difference signals Cb2b and Cr2b are delivered from the codec 210 to the encoder 212. In response, the encoder 212 modulates these color-difference signals Cb2b and Cr2b into the chrominance signal C2, which is supplied to the D/A converter 221. The chrominance signal C2 is a digital signal that was sampled at the frequency of the line-locked clock signal CLK2 (i.e., 13.5 MHz). Also, the line-locked clock signal CLK2 is supplied to the D/A converters 220 and 221 included in the second block 21.

The D/A converter 220 samples the luminance signal Y2b, output from the codec 210, at the frequency of the line-locked clock signal CLK2 (i.e., 13.5 MHz), thereby converting it into an analog luminance signal Yout. In the same way, the D/A converter 221 samples the chrominance signal C2, output from the encoder 212, at the frequency of the line-locked clock signal CLK2 (i.e., 13.5 MHz), thereby converting it into an analog chrominance signal Cout.

The video signal processor of the fourth embodiment also includes the data selector 413 and D/D converter 208. Thus, whether the processor is writing or reading, the rate at which each signal to be D/A converted by the D/A converter 220 or 221 was sampled is equal to the rate at which the D/A converter 220 or 221 samples it. Thus, there is no need to separately provide two sets of D/A converters for signals to be monitored during writing and for signals to be monitored during reading, respectively. As a result, the number of D/A converters required and the cost of the processor can be both reduced.

EMBODIMENT 5

In the processor shown in FIG. 1, the signal Yout or Cout to be output to a monitor should have the same video signal level no matter whether the processor is reading or writing. Actually, though, the level of the signal supplied to the D/A converter 220 or 221 during writing is different from during reading. A fifth embodiment of the present invention is applicable to solving this problem.

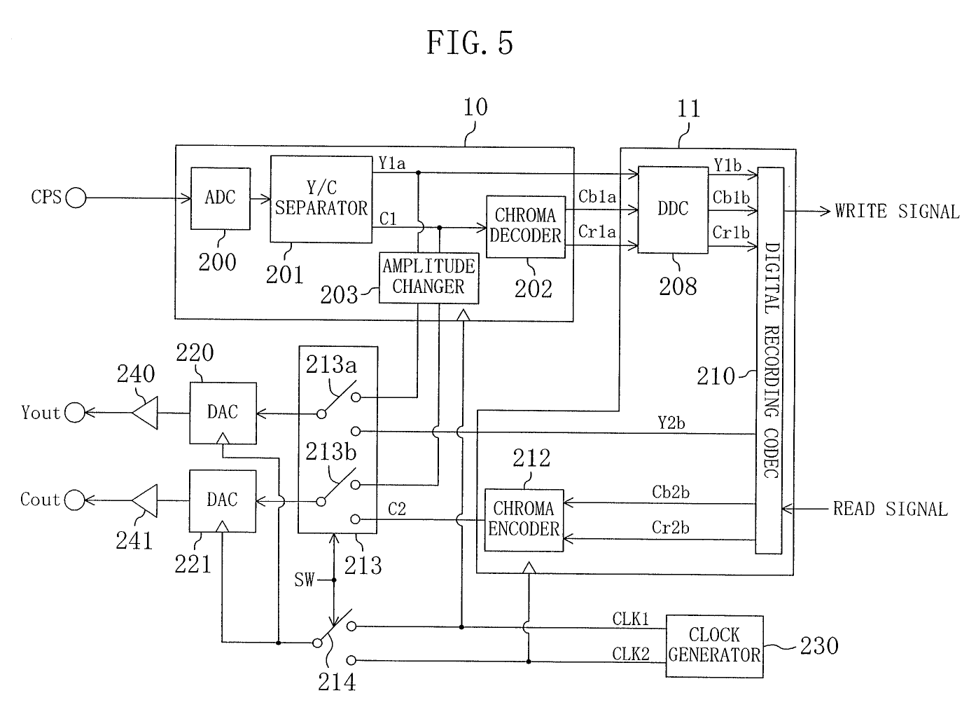

FIG. 5 is a block diagram illustrating an overall configuration for a video signal processor according to the fifth embodiment. The processor shown in FIG. 5 includes not only all the components of the processor shown in FIG. 1 but also an amplitude changer 203 and analog amplifiers 240 and 241. In the other respects, the processor shown in FIG. 5 is the same as the counterpart shown in FIG. 1.

The changer 203 is included in the write block 10 and located between the separator 201 and selector 213. The changer 203 changes and equalizes the amplitude of the luminance and chrominance signals Y1a and C1, output from the separator 201, with that of the luminance and chrominance signals Y2b and C2 output from the codec 210 and encoder 212, respectively. The amplifiers 240 and 241 amplify the output signals of the D/A converters 220 and 221, respectively.

Suppose the luminance and chrominance signals Y1a and C1 output from the separator 201 have an amplitude of 1.0, while the luminance and chrominance signals Y2b and C2 output from the codec 210 and encoder 212 have an amplitude of 1.3. In that case, the changer 203 increases the amplitude of the luminance and chrominance signals Y1a and C1 output from the separator 201 by 1.3. As a result, each signal supplied to the D/A converter 220 or 221 always has an amplitude of 1.3 no matter whether the processor is reading or writing.

The processor of the fifth embodiment includes the amplitude changer 203. Accordingly, the luminance and chrominance signals Y1a and C1 delivered from the separator 201 to the D/A converters 220 and 221 during writing can have their amplitude equalized with the luminance and chrominance signals Y2b and C2 delivered from the codec 210 and encoder 212 to the converters 220 and 221 during reading.

Without the amplitude changer 203, two sets of analog amplifiers should be separately provided to amplify signals output from the D/A converters 220 and 221 during writing and signals output from the converters 220 and 221 during reading. This is because the signals Yout and Cout output to the monitor should have the same video signal level whether the processor is reading or writing.

However, the processor of the fifth embodiment does not have to include the two sets of analog amplifiers. As a result, the number of analog amplifiers required and the cost of the processor can be both reduced.

In the fifth embodiment, the amplitude changer 203 is provided to change the amplitude of the luminance and chrominance signals Y1a and c1 output from the separator 201. Alternatively, an amplitude changer may be provided to change the amplitude of the luminance and chrominance signals Y2b and C2 output from the codec 210 and encoder 212, respectively.

What is claimed is:

1. A video signal processor comprising:
an A/D converter for sampling an analog video signal at a first frequency and converting the analog video signal into a digital video signal;
a Y/C separator for separating the digital video signal into a first luminance signal and a first chrominance signal;
a chroma decoder for demodulating the first chrominance signal into a first set of color-difference signals;
a first D/D converter for re-sampling the first luminance signal and the first set of color-difference signals at a second frequency;
a digital codec for digitally encoding the first luminance signal and the first set of color-difference signals, which have been output from the first D/D converter, to produce a write signal, and for sampling a digitally encoded read signal at the second frequency to decode the read signal into a second luminance signal and a second set of color-difference signals;
a chroma encoder for modulating the second set of color-difference signals into a second chrominance signal;
data selecting means for selecting either the first luminance and first chrominance signals, which have been output from the separator, or the second luminance and second chrominance signals, which have been output from the codec and the encoder, respectively;
clock selecting means for selecting a first clock signal with the first frequency if the data selecting means has selected the first luminance and first chrominance signals or a second clock signal with the second frequency if the data selecting means has selected the second luminance and second chrominance signals; and
D/A converters for sampling the luminance and chrominance signals that have been selected by the data selecting means at the frequency of the clock signal that has been selected by the clock selecting means, and for converting the luminance and chrominance signals into analog signals.

2. The processor of claim 1, further comprising amplitude correcting means for making up a difference in amplitude between the first luminance and first chrominance signals output from the separator and the second luminance and second chrominance signals output from the codec and the encoder, respectively.

3. The processor of claim 2, wherein the correcting means comprises an amplitude changer for changing the amplitude of the first luminance and first chrominance signals output from the separator.

4. The processor of claim 2, wherein the correcting means comprises an amplitude changer for changing the amplitude of the second luminance and second chrominance signals output from the codec and the encoder, respectively.

5. A video signal processor comprising:
an A/D converter for sampling an analog video signal at a first frequency and converting the analog video signal into a digital video signal;
a Y/C separator for separating the digital video signal into a first luminance signal and a first chrominance signal;
a chroma decoder for demodulating the first chrominance signal into a first set of color-difference signals;
a first D/D converter for re-sampling the first luminance signal and the first set of color-difference signals at a second frequency;
a digital codec for digitally encoding the first luminance signal and the first set of color-difference signals, which have been output from the first D/D converter, to produce a write signal, and for sampling a digitally encoded read signal at the second frequency to decode the read signal into a second luminance signal and a second set of color-difference signals;
a second D/D converter for re-sampling the second luminance signal and the second set of color-difference signals at the first frequency;
a chroma encoder for modulating the second set of color-difference signals, output from the second D/D converter, into a second chrominance signal;
data selecting means for selecting either the first luminance and first chrominance signals, which have been output from the separator, or the second luminance and second chrominance signals, which have been output from the second D/D converter and the encoder, respectively; and
D/A converters for sampling the luminance and chrominance signals, which have been selected by the data selecting means, at the first frequency and converting the luminance and chrominance signals into analog signals.

6. A video signal processor comprising:
an A/D converter for sampling an analog video signal at a first frequency and converting the analog video signal into a digital video signal;
a Y/C separator for separating the digital video signal into a first luminance signal and a first chrominance signal;
a chroma decoder for demodulating the first chrominance signal into a first set of color-difference signals;
a first D/D converter for re-sampling the first luminance signal and the first set of color-difference signals at a second frequency;
a digital codec for digitally encoding the first luminance signal and the first set of color-difference signals, which have been output from the first D/D converter, to produce a write signal, and for sampling a digitally encoded read signal at the second frequency to decode the read signal into a second luminance signal and a second set of color-difference signals;
a second D/D converter for re-sampling the second luminance signal and the second set of color-difference signals at the first frequency;
data selecting means for selecting either the first luminance signal and the first set of color-difference signals, which have been output from the separator and the decoder, respectively, or the second luminance signal and the second set of color-difference signals, which have been output from the second D/D converter; and
a chroma encoder for modulating the first or second set of color-difference signals, selected by the data selecting means, into a second chrominance signal; and
D/A converters for sampling the luminance signal, selected by the data selecting means, and the second chrominance signal, output from the encoder, at the first frequency and converting the luminance and chrominance signals into analog signals.

7. A video signal processor comprising:
an A/D converter for sampling an analog video signal at a first frequency and converting the analog video signal into a digital video signal;
a Y/C separator for separating the digital video signal into a first luminance signal and a first chrominance signal;
a chroma decoder for demodulating the first chrominance signal into a first set of color-difference signals;
a first D/D converter for re-sampling the first luminance signal and the first set of color-difference signals at a second frequency;
a digital codec for digitally encoding the first luminance signal and the first set of color-difference signals, which have been output from the first D/D converter, to produce a write signal, and for sampling a digitally encoded read signal at the second frequency to decode the read signal into a second luminance signal and a second set of color-difference signals;
data selecting means for selecting either the first luminance signal and the first set of color-difference signals output from the first D/D converter or the second luminance signal and the second set of color-difference signals output from the codec;
a chroma encoder for modulating the first or second set of color-difference signals, selected by the data selecting means, into a second chrominance signal; and
D/A converters for sampling the luminance signal, selected by the data selecting means, and the second chrominance signal, output from the encoder, at the second frequency and converting the luminance and chrominance signals into analog signals.
